(19) United States
(12) Patent Application Publication
(10) Pub. No.: US 2026/0066645 A1
(43) Pub. Date: Mar. 5, 2026

(54) ELECTROSTATIC DISCHARGE PROTECTION DEVICE

(71) Applicant: REALTEK SEMICONDUCTOR CORP., Hsinchu (TW)

(72) Inventor: Guan-Yi Li, Hsinchu (TW)

(73) Assignee: REALTEK SEMICONDUCTOR CORP., Hsinchu (TW)

(21) Appl. No.: 19/247,810

(22) Filed: Jun. 24, 2025

(30) Foreign Application Priority Data
Aug. 30, 2024 (TW) 113132967

(51) Int. Cl. H02H 9/02; H02H 9/00

(52) U.S. Cl. CPC H02H 9/025; H02H 9/005

(57) ABSTRACT

An electrostatic discharge protection device includes a voltage division adjustment circuit connected to a signal input end and generating a voltage signal. A trigger circuit is connected to the voltage division adjustment circuit to output a trigger signal. A detection circuit generates a detection signal according to the voltage signal. A control circuit generates an output signal according to the trigger signal and the detection signal, to control first and second switch circuits. The first and second inverters are respectively connected to the first and second switch circuits to control a discharge circuit. When static electricity is inputted into the signal input end, the output signal transitions to a high-voltage level to turn on the discharge circuit for discharging. The trigger signal transitions to a low-voltage level, to control the control circuit to extend output time of the output signal at the high-voltage level.

### CROSS-REFERENCE TO RELATED APPLICATION

This non-provisional application claims priority under 35 U.S.C. § 119(a) to Patent Application No. 113132967 filed in Taiwan, R.O.C. on Aug. 30, 2024, the entire contents of which are hereby incorporated by reference.

### BACKGROUND

### Technical Field

The present disclosure relates to an electrostatic discharge protection circuit, and in particular, to an electrostatic discharge protection device that can avoid a latch-up effect.

### Related Art

In an electronic product, electrostatic discharge (ESD) causes damage of electrical overstress (EOS) to an electronic element or an electronic system. The damage causes permanent damage to a semiconductor element, a computer system, and the like, and affects a circuit function of an integrated circuit (IC), resulting in abnormal operation of the electronic product.

After wafer packaging is performed on the integrated circuit, the integrated circuit may be damaged by static electricity during assembly, testing, storage, transfer, and other scenarios. Therefore, integrated circuits on the market start to have specifications related to electrostatic discharge, including a human body model (HBM), a mechanical discharge model (MM), a charging and discharging model (CDM), an egun, a surge, an EOS, and the like, to reproduce a damage phenomenon during electrostatic discharge, to test an electrostatic discharge capability. Therefore, an electrostatic discharge element or an electrostatic discharge circuit is used as protection for the integrated circuit, to enhance a capability of the integrated circuit to protect against electrostatic discharge, thereby improving the product yield.

### SUMMARY

The present disclosure provides an electrostatic discharge protection device, including a signal input end, a voltage division adjustment circuit, a trigger circuit, a detection circuit, a control circuit, a first switch circuit, a second switch circuit, a first inverter, a second inverter, and a discharge circuit. The signal input end is electrically connected to a voltage feed end, where a first voltage is fed to the voltage feed end. The voltage division adjustment circuit is electrically connected to the signal input end to generate a voltage signal at a voltage division node. The trigger circuit is electrically connected to a first node of the voltage division adjustment circuit to output a trigger signal. The detection circuit is electrically connected to a voltage division node of the voltage division adjustment circuit, to generate a detection signal according to the voltage signal. The control circuit is electrically connected to the trigger circuit and the detection circuit, to generate an output signal according to the trigger signal and the detection signal. The first switch circuit is electrically connected to the control circuit, to control the first switch circuit according to the output signal. The second switch circuit is electrically connected to the control circuit, to control the second switch circuit according to the output signal. The first inverter has a first input end and a first output end, and is electrically connected between the voltage feed end and a second input end, where the first input end is electrically connected to the first switch circuit. The second inverter has the second input end and a second output end, and is electrically connected between the first output end and a ground end, where the second input end is electrically connected to the second switch circuit. The discharge circuit is electrically connected between the voltage feed end and the ground end, and controlled by the first output end and the second output end. When static electricity is inputted into the signal input end, the output signal transitions to a high-voltage level, and the discharge circuit is turned on through the first switch circuit and the second switch circuit to discharge the signal input end. In this case, the trigger signal generated by the first node through the trigger circuit transitions to a low-voltage level, to control the control circuit to extend output time in which the output signal stays at the high-voltage level.

In an embodiment, the discharge circuit further includes a first discharge transistor and a second discharge transistor, the first discharge transistor and the second discharge transistor are serially connected between the voltage feed end and the ground end, the first discharge transistor is controlled by a voltage of the first output end, and the second discharge transistor is controlled by a voltage of the second output end.

In an embodiment, when the signal input end is in a normal operation mode, the voltage signal is at the low-voltage level, and the detection signal is at the high-voltage level, causing the output signal to be at the low-voltage level to turn off the first switch circuit and cause the first input end to be at the high-voltage level, and to turn on the second switch circuit and cause the second input end to be at the high-voltage level. Further, the first output end is pulled to the low-voltage level through the first inverter to turn off the first discharge transistor, and the second output end is pulled to the low-voltage level through the second inverter to turn off the second discharge transistor.

In an embodiment, the signal input end is in a discharge mode as a result of receiving the inputted static electricity, the voltage signal is at the high-voltage level, the detection signal is at the low-voltage level, and the output signal is at the high-voltage level, to turn on the first switch circuit and cause the first input end to be at the low-voltage level, and to turn off the second switch circuit and cause the second input end to be at the low-voltage level. Further, the first output end is pulled to the high-voltage level through the first inverter to turn on the first discharge transistor for discharging, and the second output end is pulled to the high-voltage level through the second inverter to turn on the second discharge transistor for discharging.

In an embodiment, the trigger circuit, the detection circuit, the control circuit, the first switch circuit, and the second switch circuit operate according to a second voltage, and the second voltage is less than the first voltage.

In an embodiment, the first voltage is 3.3 V, and the second voltage is 1.8 V.

In an embodiment, the first switch circuit further includes a first switch transistor and a second switch transistor, the first switch transistor and the second switch transistor are serially and electrically connected between the first input end and the ground end, the first switch transistor is controlled by the second voltage, and the second switch transistor is controlled by the output signal. The second switch circuit further includes a third switch transistor controlled by the output signal.

In an embodiment, the detection circuit is a detection inverter, when the static electricity is inputted into the signal input end, a voltage of the voltage signal is higher than a threshold voltage of the detection inverter, and a detection signal outputted by the detection inverter is at the low-voltage level, to cause the output signal generated by the control circuit to be at the high-voltage level.

In an embodiment, when the first node transitions from the high-voltage level to the low-voltage level due to discharging of the signal input end, the trigger signal continues to remain at the low-voltage level due to an effect of the trigger circuit until an electrostatic input period ends.

In conclusion, to avoid a latch-up effect, the present disclosure provides an electrostatic discharge protection device, which extends turn-on (discharge) time of the electrostatic discharge protection device by using a delay characteristic of potential transition through a circuit design of a trigger circuit, so that the turn-on time and turn-off time of the electrostatic discharge protection device can be the same as an electrostatic input period, to maintain a sufficiently long discharge time without an additional effect.

### BRIEF DESCRIPTION OF THE DRAWINGS

FIG. 1 is a schematic circuit diagram of an electrostatic discharge protection device according to an embodiment of the present disclosure;

FIG. 2A to FIG. 2G are schematic circuit diagrams of a trigger circuit used for an electrostatic discharge protection device according to various embodiments of the present disclosure; and

FIG. 3A to FIG. 3E are schematic circuit diagrams of a control circuit used for an electrostatic discharge protection device according to various embodiments of the present disclosure.

### DETAILED DESCRIPTION

The following provides detailed descriptions of the embodiments. However, the embodiments are merely used as examples for description, and are not intended to limit the protection scope of the present disclosure. In addition, some elements are omitted in the drawings in the embodiments to clearly show the technical features of the present disclosure. The same reference numerals in all the drawings are used to represent the same or similar elements.

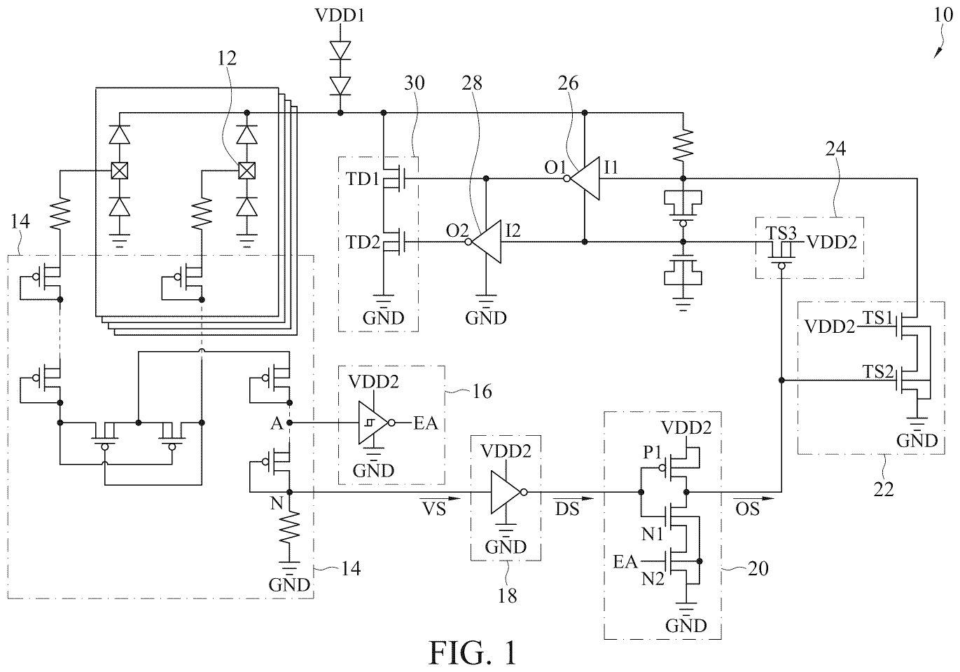

FIG. 1 is a schematic circuit diagram of an electrostatic discharge protection device according to an embodiment of the present disclosure. Referring to FIG. 1, an electrostatic discharge protection device 10 includes a signal input end 12, a voltage division adjustment circuit 14, a trigger circuit 16, a detection circuit 18, a control circuit 20, a first switch circuit 22, a second switch circuit 24, a first inverter 26, a second inverter 28, and a discharge circuit 30.

In the electrostatic discharge protection device 10, the signal input end 12 is electrically connected between a voltage feed end and a ground end GND. The signal input end 12 may be configured to input a power signal or a data signal. A first voltage VDD1 is fed to the voltage feed end. In an embodiment, the first voltage VDD1 is 3.3 V, but the present disclosure is not limited thereto. The voltage division adjustment circuit 14 is electrically connected to the signal input end 12, and has a voltage division node N and a first node A, to generate a voltage signal VS at the voltage division node N. In this embodiment, the voltage division adjustment circuit 14 includes a plurality of connected transistors, but the present disclosure is not limited thereto. The trigger circuit 16 is electrically connected to the first node A of the voltage division adjustment circuit 14, and operates according to a second voltage VDD2, where the second voltage VDD2 is less than the first voltage VDD1. In an embodiment, the second voltage VDD2 is 1.8 V, to cause the trigger circuit 16 to output a trigger signal EA. The detection circuit 18 is electrically connected between the voltage division node N of the voltage division adjustment circuit 14 and the control circuit 20, and operates according to the second voltage VDD2 to generate a detection signal DS according to the received voltage signal VS. In an embodiment, the detection circuit 18 is a detection inverter. The control circuit 20 is electrically connected to the trigger circuit 16 and the detection circuit 18, and operates according to the second voltage VDD2 to generate an output signal OS according to the trigger signal EA and the detection signal DS. In an embodiment, the control circuit 20 includes a P-type transistor P1 and two N-type transistors N1 and N2 connected in series with each other, but the present disclosure is not limited thereto.

The first switch circuit 22 is electrically connected between a first input end I1 of the first inverter 26 and the ground end GND, and is electrically connected to the control circuit 20 to be controlled by the control circuit 20, to control the first switch circuit 22 to operate according to the output signal OS. In an embodiment, the first switch circuit 22 further includes a first switch transistor TS1 and a second switch transistor TS2. The first switch transistor TS1 and the second switch transistor TS2 are serially and electrically connected between the first input end I1 and the ground end GND. The first switch transistor TS1 is controlled by the second voltage VDD2, and the second switch transistor TS2 is controlled by the output signal OS. The second switch circuit 24 is electrically connected between the control circuit 20 and a second input end I2 of the second inverter 28, and is controlled by the control circuit 20, to control the second switch circuit 24 to operate according to the output signal OS. In an embodiment, the second switch circuit 24 further includes a third switch transistor TS3, and is controlled by the output signal OS outputted by the control circuit 20. In an embodiment, the first switch transistor TS1 and the second switch transistor TS2 are N-type metal oxide semiconductor field effect transistors (NMOSFETs), and the third switch transistor TS3 is a P-type metal oxide semiconductor field effect transistor (PMOSFET).

The first inverter 26 has a first input end I1 and a first output end O1, and is electrically connected between the voltage feed end and the second input end I2, where the first input end I1 is electrically connected to the first switch circuit 22. The second inverter 28 has a second input end I2 and a second output end O2, and is electrically connected between the first output end O1 and the ground end GND, where the second input end I2 is electrically connected to the second switch circuit 24. The discharge circuit 30 is electrically connected between the voltage feed end and the ground end GND. The discharge circuit 30 includes a first discharge transistor TD1 and a second discharge transistor TD2. The first discharge transistor TD1 and the second discharge transistor TD2 are serially connected between the voltage feed end and the ground end GND. The first discharge transistor TD1 is controlled by a voltage of the first output end O1, and the second discharge transistor TD2 is controlled by a voltage of the second output end O2. In this way, when the first discharge transistor TD1 and the second discharge transistor TD2 are turned on, the signal input end 12 is directly discharged. In an embodiment, both the first discharge transistor TD1 and the second discharge transistor TD2 are N-type metal oxide semiconductor field effect transistors (NMOSFETs).

When static electricity is inputted into the signal input end 12, the output signal OS transitions to a high-voltage level, and the discharge circuit 30 is turned on through the first switch circuit 22 and the second switch circuit 24 to discharge the signal input end 12. In this case, the trigger signal EA generated by the first node A through the trigger circuit 16 transitions to a low-voltage level, to control the control circuit 20 to extend output time in which the output signal OS stays at the high-voltage level.

The electrostatic discharge protection device 10 of the present disclosure has two operation modes, including a normal operation mode and a discharge mode. The two operation modes are described in detail below.

As shown in FIG. 1, when no actual static electricity is generated or no static electricity is inputted due to electrical overstress (EOS), an input voltage at the signal input end 12 is normal. In this case, the electrostatic discharge protection device 10 operates in the normal operation mode. In the normal operation mode, the voltage signal VS generated by the voltage division adjustment circuit 14 at the voltage division node N is at the low-voltage level. The detection signal DS generated by the detection circuit 18 is at the high-voltage level, to cause the output signal OS generated by the control circuit 20 to be at the low-voltage level. The first switch circuit 22 is turned off due to the output signal OS, and the first input end I1 of the first inverter 26 is at the high-voltage level according to the first voltage VDD1. In addition, the second switch circuit 24 is turned on due to the output signal OS, and the second input end I2 is charged according to the second voltage VDD2 to cause the second input end I2 to be at the high-voltage level. The first input end I1 is at the high-voltage level, and then the first output end O1 is pulled to the low-voltage level through the first inverter 26, to turn off the first discharge transistor TD1. In addition, the second input end I2 is at the high-voltage level, and then the second output end O2 is pulled to the low-voltage level through the second inverter 28, to turn off the second discharge transistor TD2.

When there is inputted static electricity with a transient high voltage, the signal input end 12 receives the inputted static electricity, to cause the electrostatic discharge protection device 10 to be in the discharge mode. In the discharge mode, the voltage signal VS generated by the voltage division adjustment circuit 14 at the voltage division node N is at the high-voltage level. The voltage signal VS transitions to the low-voltage level due to an effect of the detection circuit 18. In this way, the detection signal DS generated by the detection circuit 18 is at the low-voltage level, and the output signal OS generated by the control circuit 20 is at the high-voltage level. The first switch circuit 22 is turned on due to the output signal OS, and a voltage of the first input end I1 is pulled down, to cause the first input end I1 to be at the low-voltage level. In addition, the second switch circuit 24 is turned off due to the output signal OS, to cause the second input end I2 to be at the low-voltage level. The first input end I2 is at the low-voltage level, and then the first output end O1 is pulled to the high-voltage level through the first inverter 26, to turn on the first discharge transistor TD1 for discharging. In addition, the second input end I2 is at the low-voltage level, and then the second output end O2 is pulled to the high-voltage level through the second inverter 28, to turn on the second discharge transistor TD2 for discharging. The trigger signal EA is generated from the first node A through the trigger circuit 16. When the inputted static electricity is generated, a voltage at the first node A increases, and the trigger signal EA transitions from the high-voltage level to the low-voltage level. In this way, the N-type transistor N2 in the control circuit 20 is turned off, thereby delaying the output time in which the output signal OS stays at the high-voltage level. When the first node A transitions from the high-voltage level to the low-voltage level due to discharging of the signal input end 12, due to a characteristic of the trigger circuit 16, the trigger signal EA may continue to remain at the low-voltage level until the electrostatic input period ends.

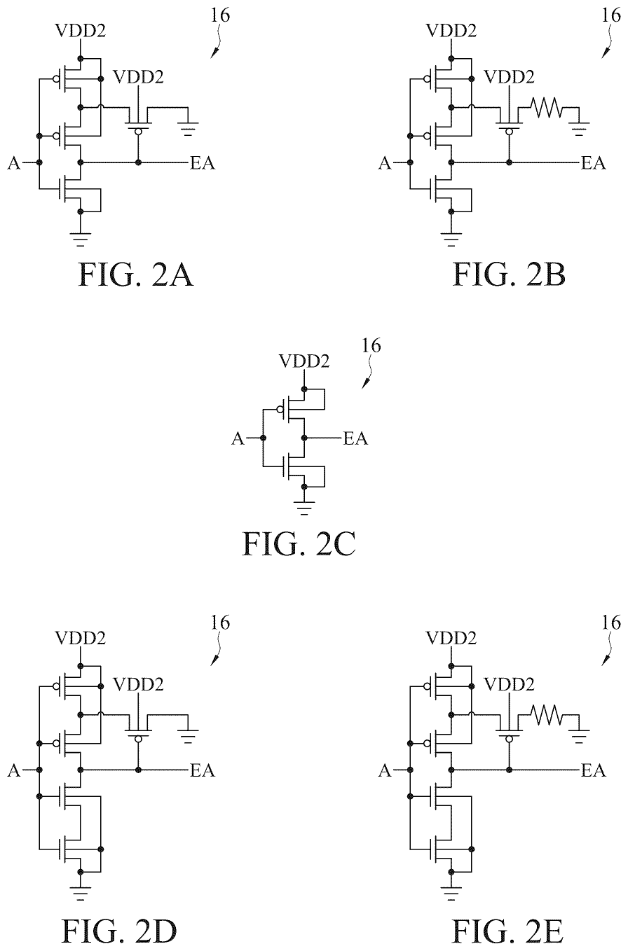

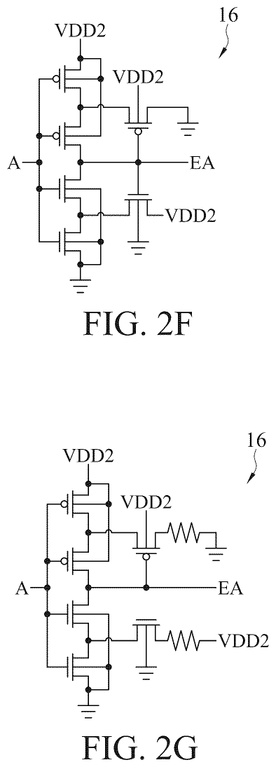

In an embodiment, the trigger circuit 16 is a Schmitt trigger, and has various different implementation aspects. As shown in FIG. 2A, the trigger circuit 16 is formed by three P-type metal oxide semiconductor field effect transistors and one N-type metal oxide semiconductor field effect transistor. As shown in FIG. 2B, the trigger circuit 16 is formed by three P-type metal oxide semiconductor field effect transistors, one N-type metal oxide semiconductor field effect transistor, and one resistor. As shown in FIG. 2C, the trigger circuit 16 is formed by one P-type metal oxide semiconductor field effect transistor and one N-type metal oxide semiconductor field effect transistor. As shown in FIG. 2D, the trigger circuit 16 is formed by three P-type metal oxide semiconductor field effect transistors and two N-type metal oxide semiconductor field effect transistors. As shown in FIG. 2E, the trigger circuit 16 is formed by three P-type metal oxide semiconductor field effect transistors, two N-type metal oxide semiconductor field effect transistors, and one resistor. As shown in FIG. 2F, the trigger circuit 16 is formed by three P-type metal oxide semiconductor field effect transistors and three N-type metal oxide semiconductor field effect transistors. As shown in FIG. 2G, the trigger circuit 16 is formed by three P-type metal oxide semiconductor field effect transistors, three N-type metal oxide semiconductor field effect transistors, and two resistors.

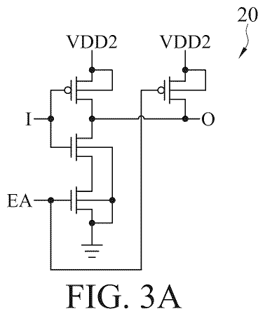

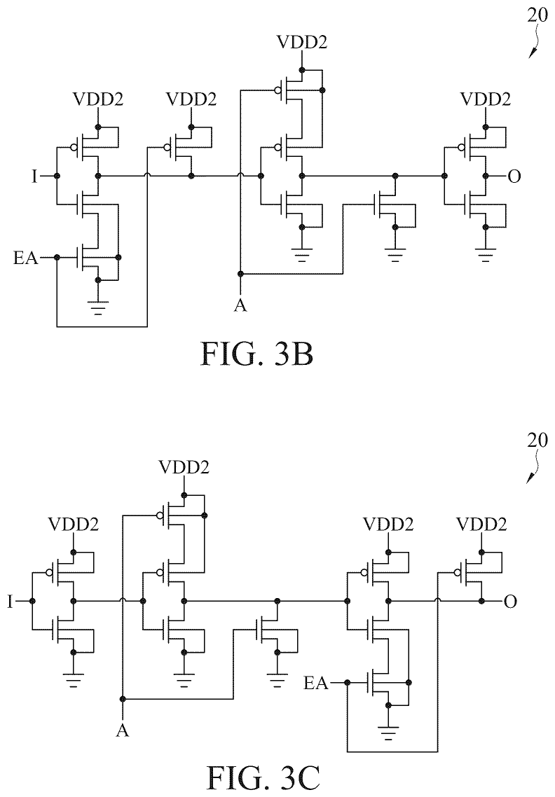

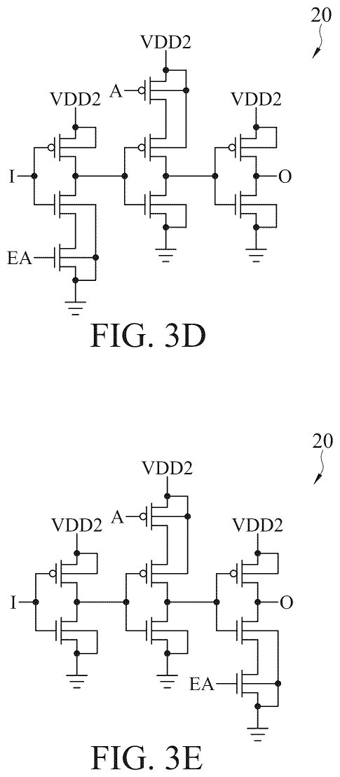

In an embodiment, in addition to the circuit architecture shown in FIG. 1, the control circuit 20 also has various implementation aspects. As shown in FIG. 3A, the control circuit 20 is formed by two P-type metal oxide semiconductor field effect transistors and two N-type metal oxide semiconductor field effect transistors. As shown in FIG. 3B, the control circuit 20 is formed by five P-type metal oxide semiconductor field effect transistors and five N-type metal oxide semiconductor field effect transistors. As shown in FIG. 3C, the control circuit 20 is formed by five P-type metal oxide semiconductor field effect transistors and five N-type metal oxide semiconductor field effect transistors. As shown in FIG. 3D, the control circuit 20 is formed by four P-type metal oxide semiconductor field effect transistors and four N-type metal oxide semiconductor field effect transistors. As shown in FIG. 3E, the control circuit 20 is formed by four P-type metal oxide semiconductor field effect transistors and four N-type metal oxide semiconductor field effect transistors.

In conclusion, the present disclosure provides an electrostatic discharge protection device, which extends turn-on (discharge) time of the electrostatic discharge protection device by using a delay characteristic of potential transition through a circuit design of a trigger circuit, so that the turn-on time and turn-off time of the electrostatic discharge protection device can be the same as an electrostatic input period, to maintain a sufficiently long discharge time without an additional effect.

Although the present disclosure has been described in considerable detail with reference to certain preferred embodiments thereof, the disclosure is not for limiting the scope of the invention. Persons having ordinary skill in the art may make various modifications and changes without departing from the scope and spirit of the disclosure. Therefore, the scope of the appended claims should not be limited to the description of the preferred embodiments described above.

What is claimed is:

1. An electrostatic discharge protection device, comprising:
a signal input end, electrically connected to a voltage feed end, wherein a first voltage is fed to the voltage feed end;
a voltage division adjustment circuit, electrically connected to the signal input end to generate a voltage signal at a voltage division node;
a trigger circuit, electrically connected to a first node of the voltage division adjustment circuit to output a trigger signal;
a detection circuit, electrically connected to a voltage division node of the voltage division adjustment circuit, to generate a detection signal according to the voltage signal;
a control circuit, electrically connected to the trigger circuit and the detection circuit, to generate an output signal according to the trigger signal and the detection signal;
a first switch circuit, electrically connected to the control circuit, to control the first switch circuit according to the output signal;
a second switch circuit, electrically connected to the control circuit, to control the second switch circuit according to the output signal;
a first inverter, having a first input end and a first output end, and electrically connected between the voltage feed end and a second input end, wherein the first input end is electrically connected to the first switch circuit;
a second inverter, having the second input end and a second output end, and electrically connected between the first output end and a ground end, wherein the second input end is electrically connected to the second switch circuit; and
a discharge circuit, electrically connected between the voltage feed end and the ground end, and controlled by the first output end and the second output end, wherein
when static electricity is inputted into the signal input end, the output signal transitions to a high-voltage level, the discharge circuit is turned on through the first switch circuit and the second switch circuit to discharge the signal input end, and the trigger signal generated by the first node through the trigger circuit transitions to a low-voltage level, to control the control circuit to extend output time in which the output signal stays at the high-voltage level.

2. The electrostatic discharge protection device according to claim 1, wherein the discharge circuit further comprises a first discharge transistor and a second discharge transistor, the first discharge transistor and the second discharge transistor are serially connected between the voltage feed end and the ground end, the first discharge transistor is controlled by a voltage of the first output end, and the second discharge transistor is controlled by a voltage of the second output end.

3. The electrostatic discharge protection device according to claim 2, wherein when the signal input end is in a normal operation mode, the voltage signal is at the low-voltage level, and the detection signal is at the high-voltage level, causing the output signal to be at the low-voltage level to turn off the first switch circuit and cause the first input end to be at the high-voltage level, and to turn on the second switch circuit and cause the second input end to be at the high-voltage level, the first output end is pulled to the low-voltage level through the first inverter to turn off the first discharge transistor, and the second output end is pulled to the low-voltage level through the second inverter to turn off the second discharge transistor.

4. The electrostatic discharge protection device according to claim 2, wherein the signal input end is in a discharge mode as a result of receiving the inputted static electricity, the voltage signal is at the high-voltage level, the detection signal is at the low-voltage level, and the output signal is at the high-voltage level, to turn on the first switch circuit and cause the first input end to be at the low-voltage level, and to turn off the second switch circuit and cause the second input end to be at the low-voltage level, the first output end is pulled to the high-voltage level through the first inverter to turn on the first discharge transistor for discharging, and the second output end is pulled to the high-voltage level through the second inverter to turn on the second discharge transistor for discharging.

5. The electrostatic discharge protection device according to claim 1, wherein the trigger circuit, the detection circuit, the control circuit, the first switch circuit, and the second switch circuit operate according to a second voltage, and the second voltage is less than the first voltage.

6. The electrostatic discharge protection device according to claim 5, wherein the first voltage is 3.3 V, and the second voltage is 1.8 V.

7. The electrostatic discharge protection device according to claim 5, wherein the first switch circuit further comprises a first switch transistor and a second switch transistor, the first switch transistor and the second switch transistor are serially and electrically connected between the first input end and the ground end, the first switch transistor is controlled by the second voltage, and the second switch transistor is controlled by the output signal; and the second switch circuit further comprises a third switch transistor controlled by the output signal.

8. The electrostatic discharge protection device according to claim 6, wherein the first switch transistor and the second switch transistor are N-type metal oxide semiconductor field effect transistors; and the third switch transistor is a P-type metal oxide semiconductor field effect transistor.

9. The electrostatic discharge protection device according to claim 1, wherein the detection circuit is a detection inverter, when the static electricity is inputted into the signal input end, a voltage of the voltage signal is higher than a threshold voltage of the detection inverter, and the detection signal outputted by the detection inverter is at the low-voltage level, to cause the output signal generated by the control circuit to be at the high-voltage level.

10. The electrostatic discharge protection device according to claim 1, wherein when the first node transitions from the high-voltage level to the low-voltage level due to discharging of the signal input end, the trigger signal continues to remain at the low-voltage level due to an effect of the trigger circuit until an electrostatic input period ends.
